(19) United States
(12) Patent Application Publication
(10) Pub. No.: US 2003/0072158 A1
(43) Pub. Date: Apr. 17, 2003

(54) Soft and elastic shaping member for flexible lamp pipe

(75) Inventor: Peter K. H. Huang, Taipei (TW)

Correspondence Address: DOUGHERTY & TROXELL, SUITE 1404, 5205 LEESBURG PIKE, FALLS CHURCH, VA, 22401, US

(73) Assignee: Shining Blick Enterprises Co., Ltd.

(21) Appl. No.: 09/975,409

(22) Filed: Oct. 12, 2001

(51) Int. Cl. F21V 21/32

(52) U.S. Cl. 362/250; 362/396; 362/418

(57) ABSTRACT

A soft and elastic shaping member for a flexible lamp pipe, the shaping member is integrally made to be flexible of soft and elastic material; and is provided at least with a pipe-like portion and a bottom plane portion adapted to being stuck to a mounting spot for placing the flexible lamp pipe in an inner channel of the pipe-like portion, and an opening provided on the top of the pipe-like portion is in communication with the inner channel. The shaping member can be mounted and positioned in pursuance of a tortuous or arciform pattern at a desired mounting spot, and the flexible lamp pipe in the shaping member can form the predetermined pattern.

### BACKGROUND OF THE INVENTION

1. Field of the Invention

The present invention is related to a soft and elastic shaping member for a flexible lamp pipe, and especially to such a shaping member suitable for positioning the flexible lamp pipe to form it into any of various tortuous or arciform patterns.

2. Description of the Prior Art

A conventional X'mas lamp string is comprised of a lot of lamp bulbs, a plurality of such lamp strings are serially connected to get a desired length, however, the electric wires thereof can only bear a predetermined load. The number of the lamp strings is limited on the one hand, and on the other hand, such conventional X'mas lamp strings are not easy to make a pattern.

The U.S. Pat. No. 4,812,956 provides a flexible lamp-string device, wherein, a groove is provided in a flexible inner pipe, the groove is placed therein a plurality of lamp strings and then is coated with a PVC pipe. Thereby, the entire lamp-string device forms a lamp pipe with a suitable size and a suitable diameter; not only the internal lamp strings thereof are variant in fashion, but also the lamp pipe can be cut or connected to form various patterns, letters or the like.

The flexible lamp pipe 20 disclosed in the U.S. Pat. No. 4,812,956, as shown in FIG. 2, has a lot of mutually separated diametrically directed holes 22 in a flexible inner pipe 21 thereof for placing in lamp bulbs 33 of all the lamp strings, and two conductors 24, 25 are combined and positioned therein when the flexible inner pipe 21 is shaped, then the transparent PVC pipe 26 is coated thereover.

However, in such flexible lamp pipes, it always needs to use small or elongate hard positioning members to connect each section of the flexible lamp pipes of a predetermined length available or obtained by cutting. The small positioning members are spaced to make the flexible lamp pipes desired patterns, letters or similar decorative patterns. Such conventional pattern-forming modes by means of flexible small positioning members are undesired by virtue that, on the one hand, the amount of the flexible small positioning members required results inconvenient working; and on the other hand, the patterns completed are undesirable in accuracy. If elongate hard positioning members making working easier are used, the flexible lamp pipes are unable to bend into tortuous or arciform patterns.

### SUMMARY OF THE INVENTION

The object of the present invention is to provide a soft and elastic shaping member for a flexible lamp pipe, wherein, the shaping member for the flexible lamp pipe of a predetermined length has an inner pipe to allow fitting of the flexible lamp pipe therein, and has an opening for pressing in the lamp pipe. In the preferred embodiment of the present invention, fixing holes are provided on the shaping member. The entire shaping member can thereby be formed of soft and elastic material, and thus can be mounted and positioned in pursuance of any of various tortuous or arciform patterns.

In the practicable embodiment, the soft and elastic shaping member can be stuck with a double-faced sticker for connecting at a mounting position by sticking.

In the practicable embodiment, the bottoms of a plurality of soft and elastic shaping members can further be allocated on the areas having printed patterns thereon.

The present invention will be apparent in its novelty and features after reading the detailed description of the preferred embodiment thereof in reference to the accompanying drawings.

### BRIEF DESCRIPTION OF THE DRAWINGS

FIG. 1 is an anatomic perspective view showing the elements of the present invention;

FIG. 2 is a partially sectional front view showing positioning of the flexible lamp pipe of FIG. 1;

FIG. 3 is a side sectional view of the flexible lamp pipe of FIG. 2;

FIG. 4 is a top view taken from FIG. 2;

FIG. 5 is a perspective view showing an embodiment the present invention which can form a pattern.

### DETAILED DESCRIPTION OF THE PREFERRED EMBODIMENT

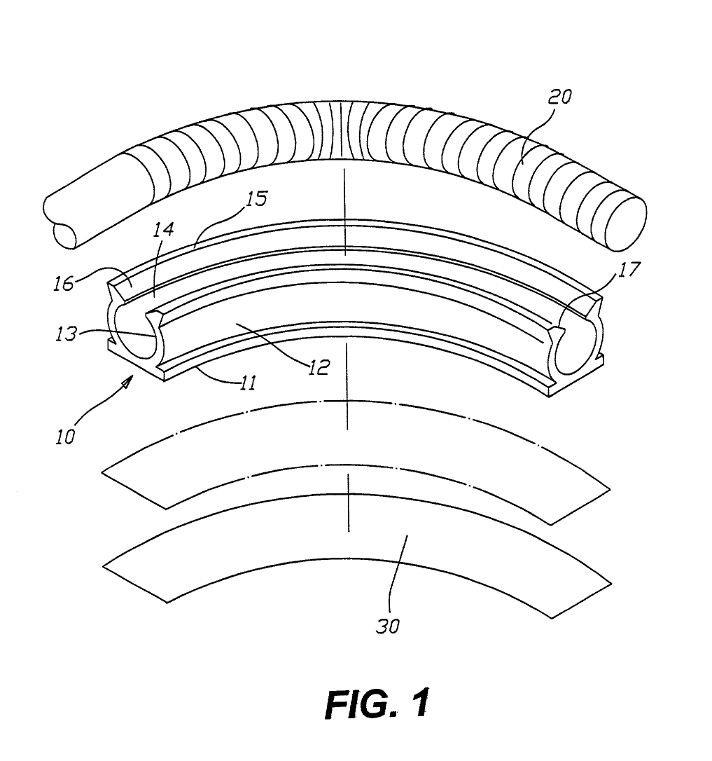

Referring to FIG. 1, the present invention is provided with a shaping member 10 of a predetermined length made of suitable material such as plastic, in order that the shaping member 10 can have desired softness, elasticity as well as flexibility.

In a preferred embodiment of the present invention, the shaping member 10 has a bottom plane portion 11 of a specific width; a pipe-like portion 12 is provided integrally on the bottom plane portion 11. The pipe-like portion 12 has an inner channel 13 of a size fitting a flexible lamp pipe 20; the inner channel 13 is communicated with an opening 14 provided on the top of the pipe-like portion 12.

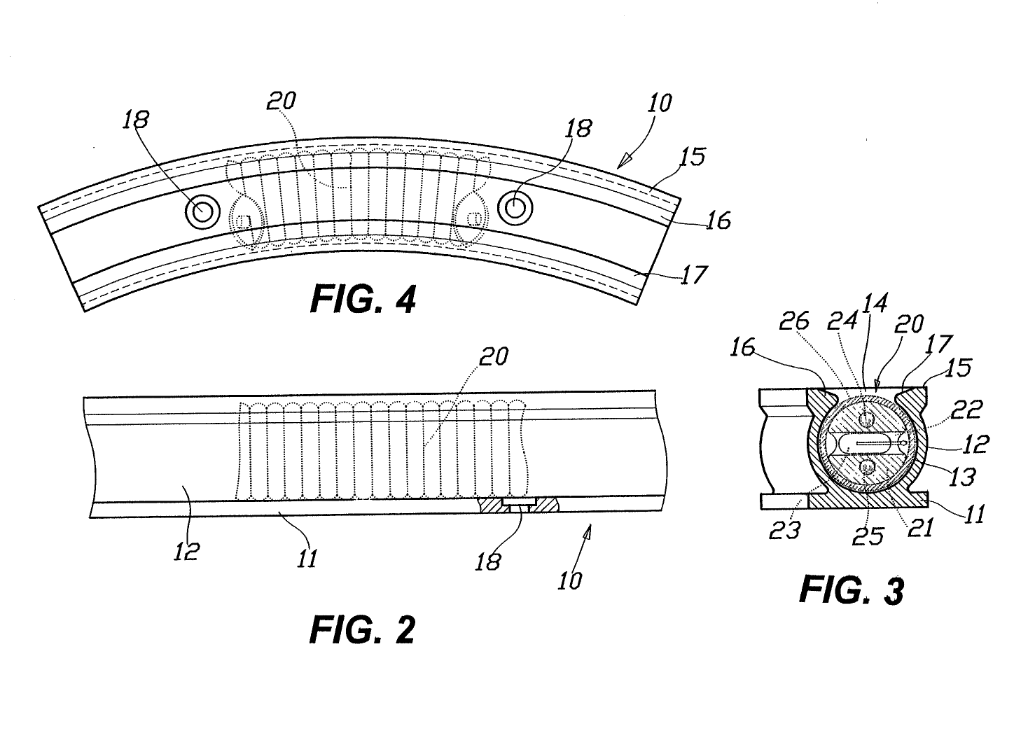

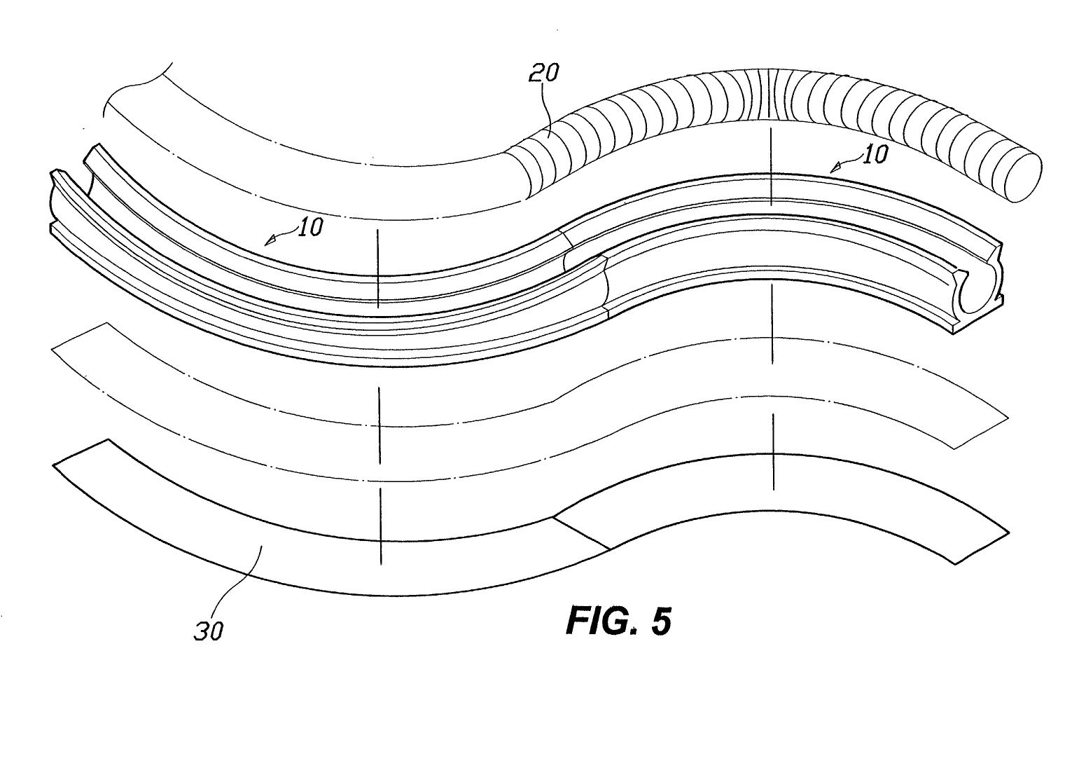

In order to form a suitable snap clamping force to conveniently mounting the flexible lamp pipe 20, the above-mentioned opening 14 has a width slightly smaller than the diameter of the inner channel 13, and an upper end face 15 of the shaping member 10 having two declining leading lateral surfaces 16, 17 are contacted with the flexible lamp pipe 20 at the opening 14, the outermost lateral edges of the two declining leading lateral surfaces 16, 17 are preferably mutually spaced to get a width slightly larger than the diameter of the flexible lamp pipe 20. Thereby, the entire flexible lamp pipe 20 can be conveniently placed on the declining leading lateral surfaces 16, 17 in advance, then are pressed down to force the opening 14 with a smaller width to open, and are mounted and positioned in the inner channel 13 (as shown in FIGS. 2-4). A connecting state can be secured by the elastic restoration force provided by the material of the pipe-like portion 12 which has been forced to open to thereby forcedly bind and position the flexible lamp pipe 20.

In the preferred embodiment of the present invention shown in FIGS. 2-4, the shaping member 10 is provided on the bottom plane portion 11 thereof with a plurality of fixing holes 18; after the shaping member 10 is fixed at an area desired, the flexible lamp pipe 20 is mounted therein. In addition to this fixed mounting mode, the bottom plane portion 11 can alternatively be stuck with a double-faced sticker for connecting at a desired mounting position by sticking.

The flexible lamp pipe 20 can be formed into a curved shape as shown in FIGS. 1 and 4 by means of the shaping member 10, and thereby is more suitable to be formed into any of various tortuous or arciform patterns.

By the feature of flexibility of the shaping member with a predetermined length of the present invention, when the present invention is used to follow any of decorative patterns, the desired pattern can be made by piecing together a plurality of paper sheets 30 with the desired patterns xerographically copied. By the fact that the spots where the flexible lamp pipe to be mounted at (such as a lateral wall surface of a building) have larger areas, the pattern can be formed by piecing together a plurality of drawing sheets with same picture made by xerographic copying, then the flexible lamp pipe 20 and the shaping members 10 for it are stuck to the pattern formed on the paper sheets 30; when the flexible lamp pipe 20 is lightened or flashes by electric connection, the predetermined pattern can be appeared.

The present invention thereby can have the flexible lamp pipe and the shaping members for it provided with larger function of pattern changing.

My invention is to be construed as including all modifications and variations falling within the scope of the appended claims.

4. (Amended) A soft and elastic shaping member for a flexible lamp pipe as claimed in claim 1, [2 or 3,] wherein; said shaping member is provided on the bottom plane portion thereof with a plurality of fixing holes.

5. (Amended) A soft and elastic shaping member for a flexible lamp pipe as claimed in claim 1, [2, or 3,] wherein, said shaping member is provided on the bottom plane portion thereof with a double-faced sticker.

6. (Amended) A soft and elastic shaping member for a flexible lamp pipe as claimed in claim 1, [2, or 3,] wherein, the bottom of said bottom plane portion of said shaping member is stuck to patterns formed on a plurality of paper sheets.

8. (New) A soft and elastic shaping member for a flexible lamp pipe as claimed in claim 2, wherein, said shaping member is provided on the bottom plane portion thereof with a plurality of fixing holes.

9. (New) A soft and elastic shaping member for a flexible lamp pipe as claimed in claim 3, wherein, said shaping member is provided on the bottom plane portion thereof with a plurality of fixing holes.

10. (New) A soft and elastic shaping member for a flexible lamp pipe as claimed in claim 2, wherein, said shaping member is provided on the bottom plane portion thereof with a double-faced sticker.

11. (New) A soft and elastic shaping member for a flexible lamp pipe as claimed in claim 3, wherein, said shaping member is provided on the bottom plane portion thereof with a double-faced sticker.

12. (New) A soft and elastic shaping member for a flexible lamp pipe as claimed in claim 2, wherein, the bottom of said bottom plane portion of said shaping member is stuck to patterns formed on a plurality of paper sheets.

13. (New) A soft and elastic shaping member for a flexible lamp pipe as claimed in claim 3, wherein, the bottom of said bottom plane portion of said shaping member is stuck to patterns formed on a plurality of paper sheets.
